(19) United States
(12) Patent Application Publication
(10) Pub. No.: US 2009/0138152 A1
(43) Pub. Date: May 28, 2009

(54) METHOD FOR ESTIMATING THE DERIVATIVE OF A MOTOR VEHICLE WHEEL SLIPPAGE AND COMPUTING UNIT FOR PERFORMING SAID ESTIMATION

(75) Inventors: Xavier Claeys, Paris (FR); Marco Marsilia, Boulogne-Bill (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT S.A.A., Boulogne Billancourt (FR)

(21) Appl. No.: 12/278,162

(22) PCT Filed: Nov. 21, 2006
(86) PCT No.: PCT/FR06/51208

§ 371 Date: Oct. 16, 2008

(30) Foreign Application Priority Data
Feb. 7, 2006 (FR) 0601070

(51) Int. Cl. B60T 8/172

(52) U.S. Cl. 701/29

(57) ABSTRACT

A method for estimating the derivative of a motor vehicle wheel slippage including: a) inputting data concerning speed of the wheels, engine torques applied on the wheels, braking pressures, engaged gearbox ratio; b) estimating acceleration of each wheel while performing a discrete derivation and a filtering of the speed of each wheel; c) estimating the torque applied to each wheel taking into account the braking pressure, engaged gearbox ratio, and clutch status; d) estimating inertia of the wheels for each of the vehicle front and rear axles; e) performing a geometric transformation of the estimate of the acceleration of each wheel estimated in b); f) estimating the derivation of the slippage of each wheel, based on the values estimated in c), d) and e).

The present invention relates to a method for estimating the derivative of the slippage of the wheels of a motor vehicle equipped with two or four drive wheels and for calculating the speed of the vehicle.

The invention is also aimed at a computing unit intended to be fitted in a motor vehicle to implement the abovementioned method, in particular for the activation logic of the brake anti-lock and/or wheel anti-skid device.

Motor manufacturers are currently carrying out numerous studies on the integration of active systems in vehicles, to improve the behavior of the vehicles and consequently the safety of the driver.

To accurately estimate the derivative of the slippage of a wheel, it is necessary to have, for each wheel of the vehicle, a sensor of the speed of the wheel, an estimation or a sensor of engine torque applied to the transmission of the vehicle, an estimation or a sensor of torque or of braking pressure applied to the wheel, an estimation of the ratio or state of the clutches if the motor torque is applied to the wheel through a gearbox.

This accurate estimation of the slippage of the acceleration is very useful in the context of producing a system for controlling the driveability or the traction of a vehicle or ABS braking.

The aim of most of the known methods is to prevent or correct the untimely slippage of the wheels of the vehicle using the acceleration of the wheel and not the acceleration of the slippage by deriving the speed of the wheels of the vehicle (example: JP59109450 and FR2415030). The information obtained is not exactly characteristic of the state of the wheel relative to the ground, even though it is relevant for performing stability or driveability checks.

Other techniques can be used to obtain the acceleration of the slippage of the wheels by using a more or less complex reference speed calculation method (see, for example, U.S. Pat. No. 5,046,787) by complementing the obtaining of the acceleration of the wheel by derivation. The information obtained in this context is not perfectly representative of the acceleration for slippage, because the reference speed is not exact since it undergoes various processing operations that cause it to drift or it is based in the case of a vehicle with two drive wheels on information on the speed of the drive wheels.

The applicant has, moreover, proposed a method of estimating the state of the wheel based on a state observer. This observer estimates a disturbance which is simply the derivative of the slippage of the wheel. The drawback of the method is that it does not correctly dissociate the phenomena between the right and left wheels. Furthermore, the estimation by filtering produces a drift of the indicator.

The aim of the present invention is to provide a method that makes it possible to enrich the information concerning the acceleration of the wheels in order to know the acceleration of the slippage of each wheel without in any way using approximation as to the reference speed of this wheel.

According to the invention, the method for estimating the derivative of the slippage of the wheels of a motor vehicle equipped with two or four drive wheels and a computing unit for implementing this method is characterized by the following steps:

a) the input of data concerning the speed of the wheels, engine torque supplied to the wheels, braking pressures, the engaged gearbox ratio,

b) the estimation of the acceleration of each wheel by performing a discrete derivation and a filtering of the speed of each wheel,

c) the estimation of the torque applied to each wheel, taking into account the braking pressure, the engaged gearbox ratio and the state of the clutch,

d) the estimation of the inertia of the wheels for each of the front and rear axles of the vehicle,

e) the implementation of a geometrical transformation of the estimation of the acceleration of each wheel estimated in b),

f) the estimation of the derivative of the slippage of each wheel, based on the values estimated in c), d) and e).

Such a method thus makes it possible to perform an accurate estimation of the slippage of each wheel of a vehicle.

Preferably, the estimation of the torque Cm applied to each wheel is performed using the following relation:

Cm=½ CL status×Tm

CL status being the gear ratio of the engaged gearbox ratio, this ratio being equal to 0 when the clutch is open and Tm is the speed of the engine, and in that the estimation of the braking torque Cf applied to each wheel is performed using the following relation:

Cf=efficiency×Pr

Pr being the braking pressure applied to the wheel.

Also preferably, the estimation of the inertia of each axle is performed using the following relations:

$$J = \frac{{J}_{powered axle} + CL status 2 {J}_{engine}}{2}$$

J powered axle being the inertia of the powered axle plus the inertia of the wheel and J engine being the inertia of the engine and CL status the gear ratio of the engaged gearbox ratio, this ratio being equal to 0 when the clutch is open.

Also preferably, the geometrical transformation according to step e) is performed using the following equations, for the four wheels of the vehicle:

$$\{ \begin{matrix}( {J}_{11} + M \cdot {r}^{2} ) \frac{{δω}_{11}}{δ t} - \frac{δ {Sx}_{11}}{δ t} \cdot M \cdot r + {\sum }_{ij \neq 11}^{ } {J}_{ij} \cdot \frac{{δω}_{ij}}{δ t} = {\sum }_{i , j} {( {Cm}_{ij} - {Cf}_{ij} )}^{ } \\ ( {J}_{12} + M \cdot {r}^{2} ) \frac{{δω}_{12}}{δ t} - \frac{δ {Sx}_{12}}{δ t} \cdot M \cdot r + {\sum }_{ij \neq 12}^{ } {J}_{ij} \cdot \frac{{δω}_{ij}}{δ t} = {\sum }_{i , j} {( {Cm}_{ij} - {Cf}_{ij} )}^{ } \\ ( {J}_{21} + M \cdot {r}^{2} ) \frac{{δω}_{21}}{δ t} - \frac{δ {Sx}_{21}}{δ t} \cdot M \cdot r + {\sum }_{ij \neq 21}^{ } {J}_{ij} \cdot \frac{{δω}_{ij}}{δ t} = {\sum }_{i , j} {( {Cm}_{ij} - {Cf}_{ij} )}^{ } \\ ( {J}_{22} + M \cdot {r}^{2} ) \frac{{δω}_{22}}{δ t} - \frac{δ {Sx}_{22}}{δ t} \cdot M \cdot r + {\sum }_{ij \neq 22}^{ } {J}_{ij} \cdot \frac{{δω}_{ij}}{δ t} = {\sum }_{i , j} {( {Cm}_{ij} - {Cf}_{ij} )}^{ }\end{matrix}$$

The indices 11 and 12 respectively designate the front right wheel and the front left wheel and the indices 21 and 22 the rear right wheel and the rear left wheel, Sx11, Sx12, Sx21, Sx22 designate the slippage of the wheels which is equal to: Sxᵢⱼ=rωᵢⱼ−V (with ij=11, 12, 21, 22), r being the radius of the wheel, ωᵢⱼ the speed of the wheel and V the speed of the vehicle, and M the weight of the vehicle and t the time.

Moreover, the derivative of the slippage of each of the four wheels of the vehicle is preferably calculated using the following equations:

$$\{ \begin{matrix}\frac{δ {Sx}_{11}}{δ t} = [ ( {J}_{11} + M \cdot {r}^{2} ) \frac{{δω}_{11}}{δ t} + {\sum }_{ij \neq 11}^{ } {J}_{ij} \cdot \frac{{δω}_{ij}}{δ t} - {\sum }_{i , j} {( {Cm}_{ij} - {Cf}_{ij} )}^{ } ] \frac{1}{M \cdot r} \\ \frac{δ {Sx}_{12}}{δ t} = [ ( {J}_{12} + M \cdot {r}^{2} ) \frac{{δω}_{12}}{δ t} + {\sum }_{ij \neq 12}^{ } {J}_{ij} \cdot \frac{{δω}_{ij}}{δ t} - {\sum }_{i , j} {( {Cm}_{ij} - {Cf}_{ij} )}^{ } ] \frac{1}{M \cdot r} \\ \frac{δ {Sx}_{21}}{δ t} = [ ( {J}_{21} + M \cdot {r}^{2} ) \frac{{δω}_{21}}{δ t} + {\sum }_{ij \neq 21}^{ } {J}_{ij} \cdot \frac{{δω}_{ij}}{δ t} - {\sum }_{i , j} {( {Cm}_{ij} - {Cf}_{ij} )}^{ } ] \frac{1}{M \cdot r} \\ \frac{δ {Sx}_{22}}{δ t} = [ ( {J}_{22} + M \cdot {r}^{2} ) \frac{{δω}_{22}}{δ t} + {\sum }_{ij \neq 22}^{ } {J}_{ij} \cdot \frac{{δω}_{ij}}{δ t} - {\sum }_{i , j} {( {Cm}_{ij} - {Cf}_{ij} )}^{ } ] \frac{1}{M \cdot r}\end{matrix}$$

The invention also relates to a computing unit intended to be fitted in a motor vehicle to implement the inventive method.

This computing unit is characterized in that it comprises:

a) a block of inputs linked to appropriate sensors for supplying data on the speed of the wheels, the engine torques applied to the wheels, the braking pressures, the engaged gearbox ratio,

b) a block for performing a discrete derivation and a filtering of the speed of each wheel and supplying an estimation of the acceleration of each wheel,

c) a block for estimating the value of the torque applied to each wheel, taking into account the braking pressure, the engaged gearbox ratio and the state of the clutch,

d) a block for performing an estimation of the inertia of the wheels for each of the front and rear axles of the vehicle,

e) a block for performing a geometrical transformation of the estimation of the acceleration of each wheel performed by the block,

f) a block for performing the estimation of the derivative of the slippage of each wheel, based on the values estimated by the blocks.

Preferably, this computing unit is then used to control an anti-lock device for the brakes and/or an anti-skid device for the wheels and for calculating a reference speed or a slippage, characterized in that the actuators of the anti-lock device for the brakes and/or anti-skid device are controlled by an activation logic using the values of the derivative of the slippage of each wheel estimated by the block.

Other features and advantages of the invention will become more apparent throughout the following description.

In the appended drawing, given by way of nonlimiting example:

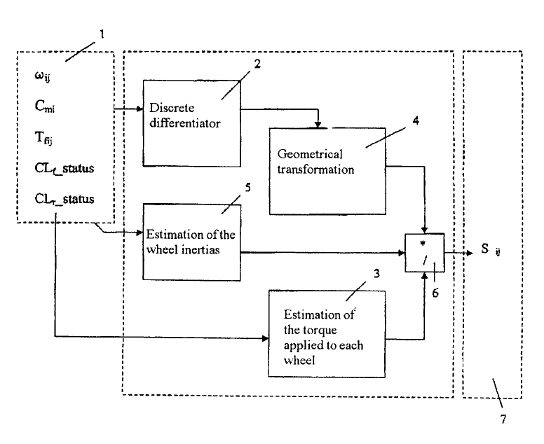

FIG. 1 is a diagram of the computing unit for implementing the inventive method.

FIG. 1 shows the various blocks or modules of the computing unit used to implement the method of estimating the slippage of the wheels of a motor vehicle.

This unit comprises a block 1 of inputs linked to appropriate sensors for supplying data on the speed of the wheels ωᵢⱼ, engine torques Cmi applied to the wheels, braking pressures Tfi, the engaged gearbox ratio CLf—status, CLr—status.

This input block 1 is linked directly to three blocks 2, 3, 5.

The block 2 performs a discrete derivation and a filtering of the speed of each wheel and supplies an estimation of the acceleration of each wheel.

The block 3 performs an estimation of the value of the torque applied to each wheel taking into account the braking pressure, the engaged gearbox ratio and the state of the clutch.

The block 5 performs an estimation of the inertia of the wheels for each of the front and rear axles of the vehicle.

The block 4, which is linked to the block 2, performs a geometrical transformation of the estimation of the acceleration of each wheel performed by block 2.

The block 6 performs the estimation of the derivative of the slippage of each wheel, based on the values estimated by the blocks 4, 5 and 3.

The calculations performed by each of the blocks hereinabove are detailed below.

Hereinafter, each of the four wheels of the vehicle will be designated by a pair of indices ij according to the following convention:

i=j, j=l→front left wheel

i=f, j=r→front right wheel

i=r, j=l→rear left wheel

i=r, j=r→rear right wheel

Also, Jij will denote the inertia equivalent to the wheel, r the radius of the wheel, N the overall gear ratio, ωᵢⱼ the angular speed of the wheel, Tmⱼ the engine torque on the axles of the vehicle (i=f, r to represent the engine torque on the front or rear axle of the vehicle), Pᵢⱼ the brake pressures on the wheel (i=f, r and j=d, g to represent a right or left wheel of the vehicle), Fᵢⱼ the external forces applied to the wheel, M the weight of the vehicle, and V the speed of the vehicle.

The input signals of the block 1 are as follows:

Engine speeds (ωᵢⱼ)

Engine torque or torques on the axles of the vehicle (Cmi)

Braking pressures (Tfᵢⱼ)

Gearbox ratio or ratios (CLf_status and CLr_status).

In the block 2, the acceleration of each wheel is obtained by discrete derivation and filtering of the wheel speed.

In block 3, the engine torque applied to each wheel can be obtained from information deriving from the actuators or by estimation.

For an electrical actuator, the torque supplied is well controlled and can be estimated using the electric current and engine speed measurements. For a heat engine, an estimation of the engine torque gives an indication concerning the torque supplied with a degree of accuracy that is average but sufficient for our estimator.

Then, the torque on each wheel is calculated by taking into consideration the gearbox ratio or the state of the clutches (or dog) between the actuator and the wheels. The differential is modeled simply in this invention but improving the calculation of the torque on the wheel can be envisaged by using a more sophisticated differential model.

Hereinafter, Cmᵢⱼ represents the engine torque on the wheel (i=f, r to represent the engine torque on the front or rear axle of the vehicle, j=r, l to represent a right or left wheel of the vehicle), Pfᵢⱼ the brake pressures on the wheel (i, j as described previously) and Cfᵢⱼ the corresponding brake torques.

An illustration of the invention consists in calculating the torque on the wheel using the following expression (perfect differential).

For the torque on the front right and left wheels:

Cm_{fr}=½ Clf_status×Tm_{f}

Cm_{fl}=½CL_status×Tm_{f}

Cf_{fr}=front_efficiency×P_{fr}

Cf_{fl}=front_efficiency×P_{fl}

For the torque on the rear right and left wheels:

Cm_{rd}=½CLr_status×Tmᵣ

Cm_{rg}=½CLr_status×Tmᵣ

Cf_{rd}=rear_efficiency×Pᵣᵣ

Cf_{rg}=rear_efficiency×Pᵣₗ

“Rear_efficiency and front_efficiency” designate the efficiencies of the brakes (quantity known and identified from elsewhere) and Cli_status (i=f, r for front, rear) the engaged ratio, this value being equal to 0 when the clutch is open.

Note:

Variants are possible to improve the estimation of the engine and brake torques in particular to:

take into account the variations of the efficiency of the brakes using observation techniques and

better represent the differential.

The block 5 estimates the inertia of the wheels of one and the same axle, for example J_{fi} for the front axle; this inertia depends on the engine inertia J_{engine} and the powered axle+wheel inertia J_{powered axle} according to the following equation:

$${J}_{fi} = \frac{{J}_{powered axle} + {CL}_{i} {\_status}^{2} \cdot {J}_{engine}}{2}$$

with CLi_status (f, r for front, rear) being the 5 engaged ratio (0 if the clutch is open).

The block 4 performs a geometrical transformation.

In the context of a vehicle with 2 or 4 drive wheels, the following equations are verified for each wheel of the vehicle:

$$\begin{matrix}{J}_{ij} \cdot \frac{{δω}_{ij}}{δ t} = {Cm}_{ij} - {Cf}_{ij} - {rF}_{ij} with i = f , l j = l , r & ( 1 ) \\ M \cdot \frac{δ V}{δ t} = {\sum }_{i , j} {F}_{ij} - {C}_{x} {v}^{2} & ( 2 )\end{matrix}$$

It will be assumed that the contribution of the aerodynamic force (−CₓV²) is negligible in the calculation of the slippage dynamic range. Because of this, the aerodynamic term disappears hereinafter in the calculation.

Sxij is used to denote the slippage of the wheel ij defined as follows:

Sxᵢⱼ=rωᵢⱼ−V

By multiplying the two terms of the equation (2) by the radius of the wheel r and by aggregating term by term the duly obtained equation with the equation (1), the following equation is obtained:

$$r \cdot M \cdot \frac{δ V}{δ t} + {\sum }_{i , j} {J}_{ij} \cdot \frac{{δω}_{ij}}{δ t} = {\sum }_{i , j} ( {Cm}_{ij} - {Cf}_{ij} ) \qquad ( 3 )$$

By deriving relating to the time t the two terms of the equation (3), the following is obtained:

$$\frac{δ V}{δ t} = r \frac{{δω}_{ij}}{δ t} - \frac{δ {Sx}_{ij}}{δ t} \qquad ( 4 )$$

It is now possible to replace the term

$$\frac{δ V}{δ t}$$

of the equation (4) with the expression in the second term of the equation (5) for any torque of index ij. The following four equations are thus obtained for the four wheels.

$$\{ \begin{matrix}( {J}_{11} + M \cdot {r}^{2} ) \frac{{δω}_{11}}{δ t} - \frac{δ {Sx}_{11}}{δ t} \cdot M \cdot r + {{\sum }_{ij \neq 11}}^{ } {J}_{ij} \cdot \frac{{δω}_{ij}}{δ t} = {\sum }_{i , j} {( {Cm}_{ij} - {Cf}_{ij} )}^{ } \\ ( {J}_{12} + M \cdot {r}^{2} ) \frac{{δω}_{12}}{δ t} - \frac{δ {Sx}_{12}}{δ t} \cdot M \cdot r + {{\sum }_{ij \neq 12}}^{ } {J}_{ij} \cdot \frac{{δω}_{ij}}{δ t} = {\sum }_{i , j} {( {Cm}_{ij} - {Cf}_{ij} )}^{ } \\ ( {J}_{21} + M \cdot {r}^{2} ) \frac{{δω}_{21}}{δ t} - \frac{δ {Sx}_{21}}{δ t} \cdot M \cdot r + {{\sum }_{ij \neq 21}}^{ } {J}_{ij} \cdot \frac{{δω}_{ij}}{δ t} = {\sum }_{i , j} {( {Cm}_{ij} - {Cf}_{ij} )}^{ } \\ ( {J}_{22} + M \cdot {r}^{2} ) \frac{{δω}_{22}}{δ t} - \frac{δ {Sx}_{22}}{δ t} \cdot M \cdot r + {{\sum }_{ij \neq 22}}^{ } {J}_{ij} \cdot \frac{{δω}_{ij}}{δ t} = {\sum }_{i , j} {( {Cm}_{ij} - {Cf}_{ij} )}^{ }\end{matrix}$$

The estimation of the derivative of the slippage for each of the four wheels is then given by:

$$\{ \begin{matrix}\frac{δ {Sx}_{11}}{δ t} = [ ( {J}_{11} + M \cdot {r}^{2} ) \frac{{δω}_{11}}{δ t} + {\sum }_{ij \neq 11}^{ } {J}_{ij} \cdot \frac{{δω}_{ij}}{δ t} - {\sum }_{i , j} {( {Cm}_{ij} - {Cf}_{ij} )}^{ } ] \frac{1}{M \cdot r} \\ \frac{δ {Sx}_{12}}{δ t} = [ ( {J}_{12} + M \cdot {r}^{2} ) \frac{{δω}_{12}}{δ t} + {\sum }_{ij \neq 12}^{ } {J}_{ij} \cdot \frac{{δω}_{ij}}{δ t} - {\sum }_{i , j} {( {Cm}_{ij} - {Cf}_{ij} )}^{ } ] \frac{1}{M \cdot r} \\ \frac{δ {Sx}_{21}}{δ t} = [ ( {J}_{21} + M \cdot {r}^{2} ) \frac{{δω}_{21}}{δ t} + {\sum }_{ij \neq 21}^{ } {J}_{ij} \cdot \frac{{δω}_{ij}}{δ t} - {\sum }_{i , j} {( {Cm}_{ij} - {Cf}_{ij} )}^{ } ] \frac{1}{M \cdot r} \\ \frac{δ {Sx}_{22}}{δ t} = [ ( {J}_{22} + M \cdot {r}^{2} ) \frac{{δω}_{22}}{δ t} + {\sum }_{ij \neq 22}^{ } {J}_{ij} \cdot \frac{{δω}_{ij}}{δ t} - {\sum }_{i , j} {( {Cm}_{ij} - {Cf}_{ij} )}^{ } ] \frac{1}{M \cdot r}\end{matrix}$$

It will be noted in this expression that the calculation of the derivative of the slippage is exact, different for a right wheel and a left wheel and no longer depends on the external forces.

The output of the system (block 7) is denoted

$$\frac{\partial {S}_{{x}_{ij}}}{\partial t} = \dot{S} {x}_{ij}$$

which represents the estimation of the derivative of the slippage.

Tests have shown that there was a very small deviation between the calculated value of the derivative of the slippage and the actual value of this derivative.

Thus, the inventive computer unit can be used to very accurately control in particular a wheel anti-lock device and/or a wheel anti-skid device of a motor vehicle.

1-7. (canceled)

8. A method for estimating the derivative of wheel slippage of a motor vehicle including two or four drive wheels and a computing unit for implementing the method, the method comprising:
a) inputting data concerning speed of the wheels, engine torque supplied to the wheels, braking pressures, engaged gearbox ratio;
b) estimating acceleration of each wheel by performing a discrete derivation and a filtering of the speed of each wheel;
c) estimating torque applied to each wheel, taking into account the braking pressure, the engaged gearbox ratio, and a state of the clutch;
d) estimating inertia of the wheels for each of front and rear axles of the vehicle;
e) implementing a geometrical transformation of the estimation of the acceleration of each wheel estimated in b);
f) estimating the derivative of the slippage of each wheel, based on the values estimated in c), d) and e).

9. The method as claimed in claim 8, wherein the estimation of the torque Cm applied to each wheel is performed using relation:
Cm=½ CL status×Tm
CL status being the gear ratio of the engaged gearbox ratio, this ratio being equal to 0 when the clutch is open, and Tm is the speed of the engine, and wherein the estimation of the braking torque Cf applied to each wheel is performed using relation:
Cf=efficiency×Pr
Pr being the braking pressure applied to the wheel.

10. The method as claimed in claim 8, wherein the estimation of the inertia of each axle is performed using relation:
$$J = \frac{{J}_{powered axle } + CL status 2 {J}_{engine}}{2}$$
J_{powered axle} being the inertia of the powered axle plus the inertia of the wheel, and J_{engine} being the inertia of the engine and CL status the gear ratio of the engaged gearbox ratio, this ratio being equal to 0 when the clutch is open.

11. The method as claimed in claim 8, the geometrical transformation according to the implementing e) is performed using equations, for the four wheels of the vehicle, of:
$$\{ \begin{matrix}( {J}_{11} + M \cdot {r}^{2} ) \frac{{δω}_{11}}{δ t} - \frac{δ {Sx}_{11}}{δ t} \cdot M \cdot r + {{\sum }_{ij \neq 11}}^{ } {J}_{ij} \cdot \frac{{δω}_{ij}}{δ t} = {\sum }_{i , j} {( {Cm}_{ij} - {Cf}_{ij} )}^{ } \\ ( {J}_{12} + M \cdot {r}^{2} ) \frac{{δω}_{12}}{δ t} - \frac{δ {Sx}_{12}}{δ t} \cdot M \cdot r + {{\sum }_{ij \neq 12}}^{ } {J}_{ij} \cdot \frac{{δω}_{ij}}{δ t} = {\sum }_{i , j} {( {Cm}_{ij} - {Cf}_{ij} )}^{ } \\ ( {J}_{21} + M \cdot {r}^{2} ) \frac{{δω}_{21}}{δ t} - \frac{δ {Sx}_{21}}{δ t} \cdot M \cdot r + {{\sum }_{ij \neq 21}}^{ } {J}_{ij} \cdot \frac{{δω}_{ij}}{δ t} = {\sum }_{i , j} {( {Cm}_{ij} - {Cf}_{ij} )}^{ } \\ ( {J}_{22} + M \cdot {r}^{2} ) \frac{{δω}_{22}}{δ t} - \frac{δ {Sx}_{22}}{δ t} \cdot M \cdot r + {{\sum }_{ij \neq 22}}^{ } {J}_{ij} \cdot \frac{{δω}_{ij}}{δ t} = {\sum }_{i , j} {( {Cm}_{ij} - {Cf}_{ij} )}^{ }\end{matrix}$$
wherein indices 11 and 12 respectively designating front right wheel and front left wheel and indices 21 and 22 rear right wheel and rear left wheel,
Sx11, Sx12, Sx21, Sx22 designating slippage of the wheels which is equal to: Sxᵢⱼ=rωᵢⱼ−V (with ij=11, 12, 21, 22), r being the radius of the wheel, ωᵢⱼ the speed of the wheel, V the speed of the vehicle, M the weight of the vehicle, and t the time.

12. The method as claimed in claim 11, wherein the derivative of the slippage of each of the four wheels of the vehicle is calculated using equations:
$$\{ \begin{matrix}\frac{δ {Sx}_{11}}{δ t} = [ ( {J}_{11} + M \cdot {r}^{2} ) \frac{{δω}_{11}}{δ t} + {\sum }_{ij \neq 11}^{ } {J}_{ij} \cdot \frac{{δω}_{ij}}{δ t} - {\sum }_{i , j} {( {Cm}_{ij} - {Cf}_{ij} )}^{ } ] \frac{1}{M \cdot r} \\ \frac{δ {Sx}_{12}}{δ t} = [ ( {J}_{12} + M \cdot {r}^{2} ) \frac{{δω}_{12}}{δ t} + {\sum }_{ij \neq 12}^{ } {J}_{ij} \cdot \frac{{δω}_{ij}}{δ t} - {\sum }_{i , j} {( {Cm}_{ij} - {Cf}_{ij} )}^{ } ] \frac{1}{M \cdot r} \\ \frac{δ {Sx}_{21}}{δ t} = [ ( {J}_{21} + M \cdot {r}^{2} ) \frac{{δω}_{21}}{δ t} + {\sum }_{ij \neq 21}^{ } {J}_{ij} \cdot \frac{{δω}_{ij}}{δ t} - {\sum }_{i , j} {( {Cm}_{ij} - {Cf}_{ij} )}^{ } ] \frac{1}{M \cdot r} \\ \frac{δ {Sx}_{22}}{δ t} = [ ( {J}_{22} + M \cdot {r}^{2} ) \frac{{δω}_{22}}{δ t} + {\sum }_{ij \neq 22}^{ } {J}_{ij} \cdot \frac{{δω}_{ij}}{δ t} - {\sum }_{i , j} {( {Cm}_{ij} - {Cf}_{ij} )}^{ } ] \frac{1}{M \cdot r} .\end{matrix}$$

13. A computing unit configured to be fitted in a motor vehicle to implement the method as claimed in claim 8, comprising:
a) a first block of inputs linked to sensors that supply data on the speed of the wheels, the engine torques applied to the wheels, the braking pressures, the engaged gearbox ratio;
b) a second block that performs a discrete derivation and a filtering of the speed of each wheel and that supplies an estimation of the acceleration of each wheel;
c) a third block that estimates the value of the torque applied to each wheel, taking into account the braking pressure, the engaged gearbox ratio, and a state of the clutch;
d) a fourth block that performs an estimation of the inertia of the wheels for each of the front and rear axles of the vehicle;
e) a fifth block that performs a geometrical transformation of the estimation of the acceleration of each wheel performed by the block; and
f) a sixth block that performs the estimation of the derivative of the slippage of each wheel, based on the values estimated by the third, fourth, and fifth blocks.

14. The computing unit as claimed in claim 13, used to control an anti-lock device for the brakes and/or an anti-skid device for the wheels and for calculating a reference speed or a slippage, wherein actuators of the anti-lock device for the brakes and/or anti-skid device are controlled by an activation logic using values of the derivative of the slippage of each wheel estimated by the sixth block.
